(19) United States
(12) Patent Application Publication
(10) Pub. No.: US 2026/0112604 A1
(43) Pub. Date: Apr. 23, 2026

(54) NEGATIVE ELECTRODE, MANUFACTURING METHOD THE SAME, AND LITHIUM SECONDARY BATTERY COMPRISING THE SAME

(71) Applicant: SK On Co., Ltd., Seoul (KR)

(72) Inventors: Hye Su HWANG, Daejeon (KR); Byung Hyuk KIM, Daejeon (KR); Ji Young PARK, Daejeon (KR)

(21) Appl. No.: 19/358,422

(22) Filed: Oct. 15, 2025

(30) Foreign Application Priority Data
Oct. 17, 2024 (KR) 10-2024-0142030
Sep. 17, 2025 (KR) 10-2025-0133612

(51) Int. Cl. H01M 4/134; H01M 4/02; H01M 4/04; H01M 4/1395; H01M 4/38; H01M 4/66; H01M 10/052

(52) U.S. Cl. CPC H01M 4/134; H01M 4/0435; H01M 4/1395; H01M 4/382; H01M 4/661; H01M 4/662; H01M 10/052; H01M 2004/021; H01M 2004/027

(57) ABSTRACT

The present disclosure relates to a negative electrode, a method of manufacturing the same, and a lithium secondary battery including the same, and, in a certain embodiment, the negative electrode may include a first region including a first metal and a second region including a second metal, wherein at least a portion of the first region is in contact with a negative electrode tab, the first metal and the second metal are different from each other, and the second metal may be lithium metal.

### CROSS-REFERENCE TO RELATED PATENT APPLICATION

The present application claims priority under 35 U.S.C. § 119 (a) to Korean patent application number 10-2024-0142030 filed on Oct. 17, 2024 and Korean patent application number 10-2025-0133612 filed on Sep. 17, 2025 in the Korean Intellectual Property Office, the entire disclosure of which is incorporated by reference herein.

### BACKGROUND OF THE INVENTION

### 1. Field

The present disclosure relates to a negative electrode, a method of manufacturing the same, and a lithium secondary battery including the same. More specifically, a negative electrode for a lithium metal battery having improved energy density and lifespan characteristics, a negative electrode having improved processability and economic efficiency, a method of manufacturing the same, and a lithium secondary battery including the same can be provided.

### 2. Description of the Related Art

Lithium metal has a low electrochemical reduction potential and a high specific capacity of 3,860 mAh/g as a negative electrode material, and a battery including a lithium metal negative electrode can significantly improve energy density per unit weight/volume compared to a conventional lithium secondary battery using a graphite negative electrode, and thus is attracting attention as a negative electrode for next-generation lithium secondary batteries.

As such a lithium metal negative electrode, a Li—Cu—Li type double-sided lithium metal negative electrode, in which lithium metal is attached to both surfaces of a copper thin film using the copper thin film as a current collector, is mainly used.

However, in such a conventional double-sided lithium metal negative electrode, a copper thin film having a thickness of about 12 μm occupies the entire area of the negative electrode, and since the density of copper is 8.96 g/cc, which is about 17 times higher than the density of lithium metal (0.53 g/cc), the above-described conventional double-sided lithium metal negative electrode inevitably causes a significant decrease in the volumetric energy density and the gravimetric energy density of the negative electrode.

Meanwhile, in order to improve the above problem, batteries configured with only lithium metal as the negative electrode have been proposed, but in such batteries, degradation occurs at a portion where the negative electrode tab is welded, causing deterioration of battery performance.

### SUMMARY OF THE INVENTION

According to one aspect of the present disclosure, a negative electrode having improved energy density and lifespan characteristics and a lithium secondary battery including the same can be provided.

According to another aspect of the present disclosure, the processability and economic efficiency of the negative electrode and the lithium secondary battery can be improved.

Meanwhile, the present disclosure can be widely applied to fields of green technology such as an electric vehicle, a battery charging station, and an energy storage system (ESS), as well as photovoltaics, wind power, and other applications using batteries. In addition, the present disclosure can be used for eco-friendly mobility, including electric vehicles and hybrid vehicles, for preventing climate change by suppressing air pollution and greenhouse gas emissions.

The negative electrode according to the present disclosure may comprise a first region including a first metal and a second region including a second metal, wherein at least a portion of the first region is in contact with a negative electrode tab, the first metal and the second metal are different from each other, and the second metal may be lithium metal.

In the negative electrode according to one embodiment, the first region may include at least one selected from the group consisting of a metal film including the first metal, a metal mesh including the first metal, and an alloy including the first metal.

In the negative electrode according to one embodiment, the first metal may be a metal having higher electrical conductivity than lithium.

In the negative electrode according to one embodiment, the first metal may include copper.

In the negative electrode according to one embodiment, the alloy may include copper and zinc.

In the negative electrode according to one embodiment, the negative electrode may further include a third region located between the first region and the second region and including both the first metal and the second metal.

In the negative electrode according to one embodiment, the first region includes a first metal plate including the first metal, the second region includes a second metal plate made of the second metal, and the third region may have the first metal plate exposed on one surface thereof and the second metal plate exposed on the other surface thereof.

In the negative electrode according to one embodiment, a width of the third region may be 0.1 mm to 4 mm.

In the negative electrode according to one embodiment, an area of the third region may be 0.05% to 5% of an entire area of the negative electrode.

The method of manufacturing the negative electrode according to the present disclosure may comprise: preparing a first metal plate including the first metal and a second metal plate including the second metal; positioning the first metal plate and the second metal plate to form a bonded portion in which at least a portion of the first metal plate and at least a portion of the second metal plate overlap each other; and forming a bonded body of the first metal plate and the second metal plate by rolling the bonded portion while maintaining the positioning.

In the method of manufacturing the negative electrode according to one embodiment, a width of the bonded portion may be 0.1 mm to 4 mm.

In the method of manufacturing the negative electrode according to one embodiment, the forming of the bonded body of the first metal plate and the second metal plate may include a first surface rolling step of performing rolling on one exposed surface of the bonded portion and a second surface rolling step of performing rolling on the other exposed surface of the bonded portion.

In the method of manufacturing the negative electrode according to one embodiment, the method may further comprise notching the bonded body of the first metal plate and the second metal plate, wherein the notching may be performed such that the bonded portion is included, at least a portion of the first metal plate is included on one side adjacent to the bonded portion, and at least a portion of the second metal plate is included on the other side adjacent to the bonded portion.

The lithium secondary battery according to the present disclosure may comprise a positive electrode and the negative electrode according to the present disclosure, wherein the positive electrode may include a positive electrode coated portion which is a region where a positive electrode active material layer is formed on at least one surface of a positive electrode current collector, and a positive electrode uncoated portion protruding outward from the positive electrode coated portion.

In the lithium secondary battery according to one embodiment, the lithium secondary battery may include at least one of the positive electrode and at least one of the negative electrode, and the positive electrode and the negative electrode may be alternately stacked along a first direction.

In the lithium secondary battery according to one embodiment, when the lithium secondary battery is orthogonally projected onto an imaginary plane perpendicular to the first direction, the positive electrode coated portion may be included in the second region of the negative electrode.

According to one aspect of the present disclosure, a negative electrode having improved energy density and lifespan characteristics and a lithium secondary battery including the same can be provided.

According to another aspect of the present disclosure, the processability and economic efficiency of the negative electrode and the lithium secondary battery can be improved.

Meanwhile, the present disclosure can be widely applied to fields of green technology such as electric vehicles, battery charging stations, and energy storage systems (ESS), as well as photovoltaics, wind power, and other applications using batteries. In addition, the present disclosure can be used for eco-friendly mobility, including electric vehicles and hybrid vehicles, for preventing climate change by suppressing air pollution and greenhouse gas emissions.

### BRIEF DESCRIPTION OF THE DRAWINGS

FIG. 1 is a view illustrating a negative electrode according to one embodiment of the present disclosure.

FIG. 2 is a view illustrating a negative electrode according to another embodiment of the present disclosure.

FIG. 3 is a view illustrating steps of a method of manufacturing a negative electrode according to one embodiment of the present disclosure.

FIG. 4 is a view schematically illustrating processes of each step in the method of manufacturing a negative electrode according to one embodiment of the present disclosure.

FIG. 5 is a view for explaining a positive electrode according to one embodiment of the present disclosure.

FIG. 6 is a view showing an embodiment of an arrangement relationship between a positive electrode and a negative electrode according to one embodiment of the present disclosure.

FIG. 7 is a view for explaining an embodiment of a lithium secondary battery according to one embodiment of the present disclosure.

FIG. 8 is a view for explaining a structure of a negative electrode according to Example 2.

FIG. 9 is a view for explaining a structure of a negative electrode according to Comparative Example 1.

FIG. 10 is a view for explaining a structure of a negative electrode according to Reference Example.

FIG. 11 is a graph showing evaluation results of lifespan characteristics of cells of Example 1, Example 2, Comparative Example 1, and Reference Example.

### DETAILED DESCRIPTION

The embodiments described in the present specification may be modified into various other forms, and thus the technology according to one embodiment is not limited to the embodiments described below. Furthermore, throughout the specification, unless otherwise expressly stated, the terms “comprises,” “includes,” “contains,” or “has” do not exclude other elements but mean that other elements may be further included, and do not exclude elements, materials, or processes not additionally enumerated.

The numerical ranges used in the present specification include lower and upper limits, all values within the range, increments logically derivable from the form and width of the defined range, all values doubly limited, and all possible combinations of the upper and lower limits of numerical ranges defined in different forms.

In the present specification, the term “electrically connected” may mean, without limitation, all connection methods in which a plurality of objects can be connected to be electrically communicated with each other, and may be implemented in various manners such that the plurality of objects to be interconnected are directly connected or connected via a third object.

Unless otherwise defined in the present specification, the term “about” may be considered as a value within 30%, 25%, 20%, 15%, 10%, or 5% of the specified value.

The term “lithium secondary battery” used in the present specification may mean a battery that generates electrical energy through an oxidation-reduction reaction when lithium ions are inserted into and extracted from a positive electrode and a negative electrode.

The term “lithium metal battery” used in the present specification may mean a lithium secondary battery in which the negative electrode includes lithium metal.

Hereinafter, the present disclosure will be described in detail. However, this is merely exemplary and the present disclosure is not limited to the specific embodiments described as examples.

### Negative Electrode

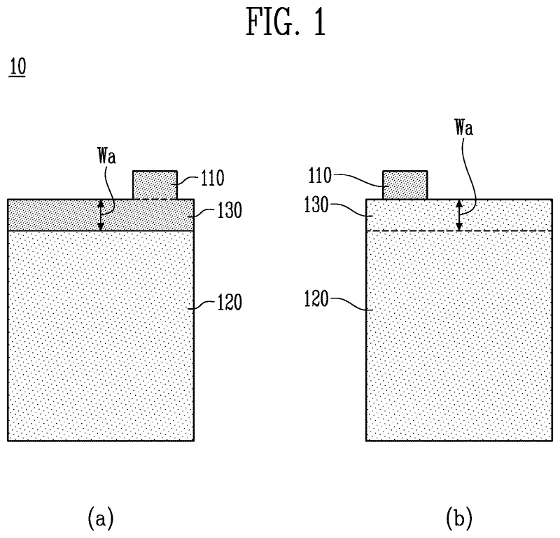

FIG. 1 is a view illustrating a negative electrode according to one embodiment of the present disclosure.

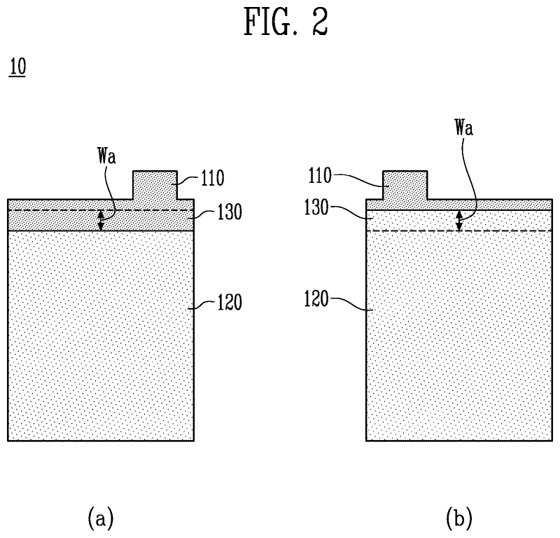

FIG. 2 is a view illustrating a negative electrode according to another embodiment of the present disclosure.

The negative electrode 10 according to one embodiment of the present disclosure may include a first region 110 including a first metal and a second region 120 including a second metal, and at least a portion of the first region 110 is in contact with a negative electrode tab, the first metal and the second metal are different from each other, and the second metal may be lithium metal.

FIGS. 1 and 2 are views illustrating a negative electrode 10 according to one embodiment. Meanwhile, (a) of FIG. 1 is a view showing the negative electrode 10 according to one embodiment as viewed from one direction, and (b) of FIG. 1 is a view showing the negative electrode 10 of (a) of FIG. 1 as viewed from a direction opposite to the one direction. Similarly, (a) of FIG. 2 is a view showing the negative electrode 10 according to another embodiment as viewed from one direction, and (b) of FIG. 2 is a view showing the negative electrode 10 of (a) of FIG. 2 as viewed from a direction opposite to the one direction.

As shown in FIGS. 1 and 2, the negative electrode 10 may include a first region 110 and a second region 120. Meanwhile, as will be described later, the negative electrode 10 may further include a third region 130 located between the first region 110 and the second region 120 and including both the first metal and the second metal. Details thereof will be described later.

The first region 110 may include a region corresponding to an uncoated portion of a conventional negative electrode, and, as in the uncoated portion of the conventional negative electrode, a negative electrode tab may be grounded and attached to the first region 110. However, the shape of the negative electrode according to one embodiment of the present disclosure is not limited to the shapes shown in FIGS. 1 and 2, and various shapes may be adopted as needed.

The negative electrode tab may mean a configuration that electrically connects the negative electrode and a lead.

In one embodiment, the negative electrode tab may include copper, aluminum, or nickel. In a specific embodiment, the negative electrode tab may include nickel.

In one embodiment, the first region 110 may include at least one selected from the group consisting of a metal film including the first metal, a metal mesh including the first metal, and an alloy including the first metal. As a non-limiting example, the first region 110 may be formed of a metal film or foil including the first metal. In another example, the first region 110 may be formed of a metal mesh including the first metal. In still another example, the first region 110 may be formed of an alloy including the first metal. In yet another example, the first region 110 may be formed of a composite including any two or more of the metal film, the metal mesh, and the alloy.

In one embodiment, the first metal may be a metal having higher electrical conductivity than lithium. In this case, the electrical conductivity may refer to electrical conductivity at room temperature. The electrical conductivity of lithium is about 1.1×10⁷S/m at room temperature, and the first metal may refer to a metal having electrical conductivity equal to or higher than the above value at room temperature.

In one embodiment, the first metal may include copper, nickel, aluminum, or zinc. In a specific embodiment, the first metal may include copper.

In one embodiment, the alloy may be an alloy including the first metal. In a specific embodiment, the alloy may be an alloy including copper. In a more specific embodiment, the alloy may be an alloy including copper and zinc.

In one embodiment, the first region 110 may include a first metal plate including the first metal.

Meanwhile, in one embodiment, the first metal plate may include at least one selected from the group consisting of a metal film including the first metal, a metal mesh including the first metal, and an alloy including the first metal. In another example, the first region 110 may be formed of a composite including any two or more of the metal film, the metal mesh, and the alloy.

In such an embodiment, the first region 110 may mean a region including the first metal and including the first metal plate.

In one embodiment, the second region 120 may include a second metal.

In one embodiment, the second region 120 may be essentially composed of the second metal.

In one embodiment, the second region 120 may be made of the second metal.

In one embodiment, the second metal may be lithium metal. In a specific embodiment, the first metal and the second metal may be different from each other. According to such an embodiment, the first metal may mean a metal having high electrical conductivity other than lithium metal. Metals corresponding thereto may be the same as described above.

As a non-limiting example, the lithium metal may mean pure lithium metal, lithium metal having a protective layer formed thereon for suppressing dendrite growth, or a lithium metal alloy. Alternatively, as necessary, the lithium metal may mean lithium metal in which a dopant other than lithium metal is partially doped. Meanwhile, as a non-limiting example, the second region 120 may be formed of a lithium metal thick film. The second region 120 may be formed in a single-layer structure; however, it is not necessarily limited thereto and may be formed in a multilayer structure such as a double layer, triple layer, or quadruple layer, as necessary.

In one embodiment, the second region 120 may include a second metal plate made of the second metal.

In such an embodiment, the second region 120 may mean a region including the second metal and including the second metal plate. In a specific embodiment, the second region 120 may mean a region essentially composed of the second metal by including the second metal plate.

As described above, the second region 120 may mean a region composed only of the second metal, and in a specific example, composed only of lithium metal. The second region 120 may include at least a portion of a region corresponding to a holding portion of a conventional negative electrode. The lithium metal may allow insertion and extraction (and/or attachment and detachment, etc.) of lithium ions while having high electrical conductivity, thereby performing both the role of a current collector and an active material layer in a conventional negative electrode. Accordingly, the second region 120 may be configured to face the positive electrode in the battery.

As shown again in FIGS. 1 and 2, the negative electrode 10 may include the third region 130. The third region 130 may mean a region located between the first region 110 and the second region 120. Meanwhile, the third region 130 may mean a region including both the first metal and the second metal.

In one embodiment, the negative electrode 10 may further include a third region 130 located between the first region 110 and the second region 120 and including both the first metal and the second metal.

In an exemplary embodiment, the third region 130 may be divided into two portions based on a thickness direction of the negative electrode 10, wherein a portion adjacent to one side in the thickness direction may include only one of the first metal and the second metal, and a portion adjacent to the other side may include only the other one of the first metal and the second metal.

Meanwhile, as described above, the first region 110 may include the first metal plate, and the second region 120 may include the second metal plate. In this case, the third region 130 may mean a region where the first metal plate and the second metal plate are bonded.

In one embodiment, the first region 110 includes a first metal plate including the first metal, the second region 120 includes a second metal plate made of the second metal, and the third region 130 may have the first metal plate exposed on one surface thereof and the second metal plate exposed on the other surface thereof.

That is, unlike the first region 110 including the first metal plate and the second region 120 essentially composed of the second metal plate, the third region 130 is a region in which the first metal plate and the second metal plate are bonded to each other, and may be distinguished from the first region 110 and the second region 120 in that it is a region including both the first metal plate and the second metal plate.

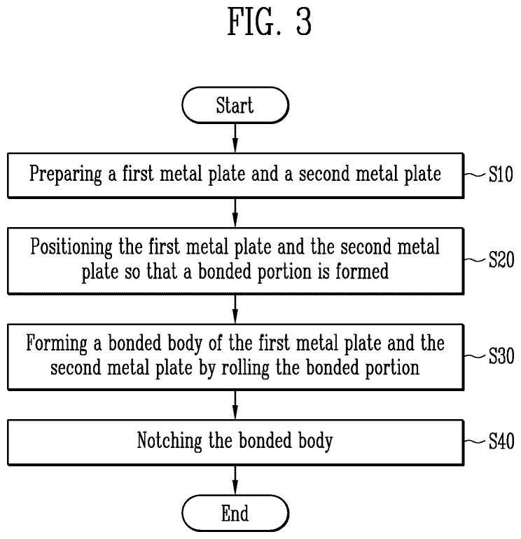

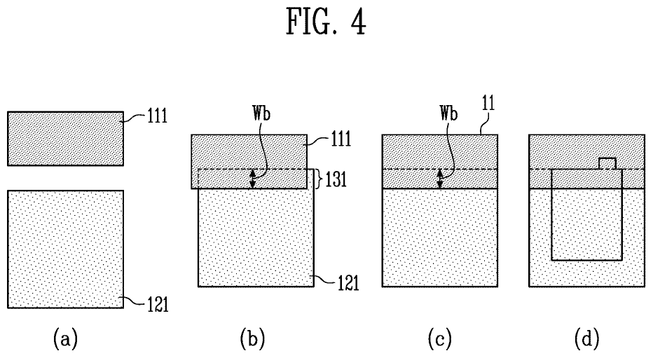

Meanwhile, the bonding may mean that the first metal plate and the second metal plate are bonded to each other in a manner in which respective wide surfaces of the first metal plate and the second metal plate are in contact with each other through pressing or the like. Details thereof may be understood with reference to FIGS. 3 and 4 together with the description of the manufacturing method to be described later.

In one embodiment, the third region 130 may have the first metal plate exposed on one surface thereof and the second metal plate exposed on the other surface thereof.

According to the above description regarding the bonding, the third region 130 may have the first metal plate exposed on one surface thereof and the second metal plate exposed on the other surface thereof.

That is, referring to FIGS. 1 and 2, when the negative electrode 10 is viewed from one direction as shown in (a) of FIGS. 1 and 2, the third region 130 may have the first metal plate exposed to the outside, and when the negative electrode 10 is viewed from a direction opposite to the one direction as shown in (b) of FIGS. 1 and 2, the third region 130 may have the second metal plate exposed to the outside.

Referring again to FIGS. 1 and 2, in one embodiment, a width Wa of the third region 130 may be 0.1 mm to 4 mm. In a specific embodiment, the width Wa of the third region 130 may be 0.5 mm to 3 mm, and in a more specific embodiment, may be 1 mm to 2 mm.

As described above, the third region 130 may be located between the first region 110 and the second region 120. Therefore, referring to FIGS. 1 and 2, the width Wa of the third region 130 may mean each length of the third region 130 in a direction in which the first region 110, the third region 130, and the second region 120 are sequentially located. In one embodiment, when the third region 130 is a region including a plane having at least one pair of parallel sides, a distance between the parallel sides in the third region 130 may be 0.1 mm to 4 mm, specifically 0.5 mm to 3 mm, and more specifically 1 mm to 2 mm.

When the width Wa of the third region 130 is less than the above-described numerical range, the first metal plate and the second metal plate may not be properly bonded, thereby reducing structural stability of the negative electrode 10, and consequently causing deterioration in battery characteristics of a secondary battery including the same. When the width exceeds the above-described numerical range, in a secondary battery including the positive electrode 20 and the negative electrode 10 formed with a predetermined area, as will be described later, the active material layer 220 of the positive electrode 20 facing the negative electrode 10 may face the first region 110 of the negative electrode 10, thereby causing problems such as lithium dendrite formation or induction of a short circuit.

Referring again to FIGS. 1 and 2, in one embodiment, an area of the third region 130 may be 0.05% to 5% of an entire area of the negative electrode 10. In a specific embodiment, the area of the third region 130 may be 0.07% to 4.5% of the entire area of the negative electrode 10, and in a more specific embodiment, may be 0.1% to 4% of the entire area of the negative electrode 10.

In an exemplary embodiment, the entire area of the negative electrode 10 may have a value equal to the total sum of the areas of the first region 110, the second region 120, and the third region 130.

When the area of the third region 130 relative to the entire area of the negative electrode 10 is less than the above-described numerical range, the first metal plate and the second metal plate may not be properly bonded, thereby reducing the structural stability of the negative electrode 10, and consequently causing deterioration in battery characteristics of a secondary battery including the same. When the area exceeds the above-described numerical range, in terms of the structure of the positive electrode 20 and the negative electrode 10, the active material layer 220 of the positive electrode 20 facing the negative electrode 10 may face the first region 110 of the negative electrode 10, thereby causing problems such as lithium dendrite formation or induction of a short circuit.

In one embodiment, the negative electrode 10 including the first region 110, the second region 120, and the third region 130 may be included in the form of a bonded body of dissimilar metal plates. As in the method of manufacturing a negative electrode according to one embodiment of the present disclosure described later, it may be included by positioning at least a portion of a first metal plate 111 including the first metal and at least a portion of a second metal plate 121 including the second metal so as to overlap each other, and then forming a bonded body by rolling.

The negative electrode according to one embodiment of the present disclosure may include, as described above, the first region 110 including the first metal plate, the second region 120 including the second metal plate, and the third region 130, which is a region in which the first metal plate and the second metal plate are bonded. The first region 110 may be in contact with a negative electrode tab as in an uncoated portion of a conventional negative electrode, and the second region 120 may be composed of lithium metal. The negative electrode according to one embodiment of the present disclosure can significantly improve the volumetric energy density and the gravimetric energy density compared to a conventional lithium metal negative electrode including a separate negative electrode current collector and including lithium metal as an active material layer on at least one surface of the current collector.

Meanwhile, when the entire negative electrode is composed of lithium metal, the negative electrode tab may be in direct contact with the lithium metal. In such a case, when the contact portion with the negative electrode tab is exposed to the electrolyte, an electrochemical reaction with the positive electrode is accompanied during charge/discharge operation. At this time, the current density around the contact portion to which current is directly supplied from the negative electrode tab may locally increase, causing lithium ions to be rapidly consumed near the contact portion, which may lead to degradation of cell performance, such as deterioration of cell performance and short-circuiting. The negative electrode according to one embodiment of the present disclosure may be configured such that the portion in contact with the tab is composed of a metal other than lithium having high electrical conductivity, and the remaining portion is composed of lithium metal, thereby improving energy density while preventing deterioration of cell performance.

### Method of Manufacturing the Negative Electrode

FIG. 3 is a view illustrating steps of a method of manufacturing a negative electrode according to one embodiment of the present disclosure.

FIG. 4 is a view schematically illustrating processes of each step in the method of manufacturing a negative electrode according to one embodiment of the present disclosure.

Referring to FIGS. 3 and 4, the method of manufacturing a negative electrode according to one embodiment of the present disclosure may comprise: a step S10 of preparing a first metal plate 111 including the first metal and a second metal plate 121 including the second metal; a step S20 of positioning the first metal plate 111 and the second metal plate 121 so as to have a bonded portion 131 in which at least a portion of the first metal plate 111 and at least a portion of the second metal plate 121 overlap each other; and a step S30 of forming a bonded body 11 of the first metal plate 111 and the second metal plate 121 by rolling the bonded portion 131 while maintaining the positioning of the bonded portion 131.

In one embodiment, in the step S10 of the preparing the first metal plate 111 including the first metal and the second metal plate 121 including the second metal, the first metal plate 111 may include at least one selected from the group consisting of a metal film including the first metal, a metal mesh including the first metal, and an alloy including the first metal. As a non-limiting example, the first metal plate 111 may be formed of a metal film or foil including the first metal. In another example, the first metal plate 111 may be formed of a metal mesh including the first metal. In still another example, the first metal plate 111 may be formed of an alloy including the first metal. In yet another example, the first metal plate 111 may be formed of a composite including any two or more of the metal film, the metal mesh, and the alloy.

In one embodiment, the first metal may be a metal having higher electrical conductivity than lithium. In this case, the electrical conductivity may refer to electrical conductivity at room temperature. The electrical conductivity of lithium is about 1.1×107 S/m at room temperature, and the first metal may refer to a metal having electrical conductivity equal to or greater than the above value at room temperature.

In one embodiment, the first metal may include copper, nickel, aluminum, or zinc. In a specific embodiment, the first metal may include copper.

In one embodiment, the alloy may be an alloy including the first metal. In a specific embodiment, the alloy may be an alloy including copper. In a more specific embodiment, the alloy may be an alloy including copper and zinc.

In one embodiment, the second metal plate 121 may include a second metal.

In one embodiment, the second metal plate 121 may be essentially composed of the second metal.

In one embodiment, the second metal plate 121 may be made of the second metal.

In one embodiment, the second metal may be lithium metal. In a specific embodiment, the first metal and the second metal may be different from each other. According to such an embodiment, the first metal may mean a metal having high electrical conductivity other than lithium metal. Metals corresponding thereto may be the same as described above.

As a non-limiting example, the lithium metal may be pure lithium metal, lithium metal having a protective layer formed thereon for suppressing dendrite growth, or a lithium metal alloy. As a non-limiting example, the second metal plate 121 may be a lithium metal thick film. The second metal plate may be formed in a single-layer structure; however, it is not necessarily limited thereto and may be formed in a multilayer structure such as a double layer, triple layer, or quadruple layer, as necessary.

Referring to (a) of FIG. 4, as a non-limiting example, the first metal plate 111 and the second metal plate 121 may be prepared in a plate shape in which at least one surface has at least one pair of parallel sides. As a non-limiting example, the first metal plate 111 and the second metal plate 121 may be prepared in a plate shape in which at least one surface has a rectangular shape. When the first metal plate 111 and the second metal plate 121 are prepared in a plate shape, the first metal plate 111 may, without limitation, be prepared to have a thickness of 5 μm to 15 μm, and the second metal plate 121 may, without limitation, be prepared to have a thickness of 50 μm to 130 μm.

In one embodiment, in the step S20 of the positioning the first metal plate 111 and the second metal plate 121 so as to have a bonded portion 131 in which at least a portion of the first metal plate 111 and at least a portion of the second metal plate 121 overlap each other, the first metal plate 111 and the second metal plate 121 may refer to the first metal plate 111 and the second metal plate 121 prepared in the above-described step S10.

The bonded portion 131 may mean a portion in which at least a portion of the first metal plate 111 and at least a portion of the second metal plate 121 are in contact with each other, or a portion adjacent within a range that a person skilled in the art to which the present disclosure pertains would recognize as being substantially equivalent to being in contact.

Specifically, when the first metal plate 111 and the second metal plate 121 are prepared in a plate shape, the bonded portion 131 may mean a portion where the first metal plate 111 and the second metal plate 121 are in contact in a plate thickness direction, or a portion adjacent in the manner described above.

Referring to (b) of FIG. 4, when the first metal plate 111 and the second metal plate 121 are prepared in a plate shape in which at least one surface has at least one pair of parallel sides as described above, at least one of each pair of parallel sides of the first metal plate 111 may be positioned adjacent to at least one of each pair of parallel sides of the second metal plate 121 so that the first metal plate 111 and the second metal plate 121 overlap each other. In this case, each adjacent side may be positioned to be parallel to each other. In such a case, the bonded portion 131, which is a region in which the first metal plate 111 and the second metal plate 121 overlap, may be formed such that at least one surface exposed to the outside has at least one pair of parallel sides.

Referring again to FIG. 4, in one embodiment, a width Wb of the bonded portion 131 may be 0.1 mm to 4 mm. In a specific embodiment, the width Wb of the bonded portion 131 may be 0.5 mm to 3 mm, and in a more specific embodiment, may be 1 mm to 2 mm.

Referring to FIG. 4, the width Wb of the bonded portion 131 may mean each length of the bonded portion 131 in a direction in which the first metal plate 111 and the second metal plate 112 overlap.

As a non-limiting example, the first metal plate 111 and the second metal plate 121 may be positioned to overlap by 0.1 mm to 4 mm. In a specific example thereof, the first metal plate 111 and the second metal plate 112 may be positioned to overlap by 0.5 mm to 3 mm, and in a more specific example, may be positioned to overlap by 1 mm to 2 mm. In one embodiment, when at least one surface of the bonded portion 131 exposed to the outside is formed to have at least one pair of parallel sides, the distance between the parallel sides of the bonded portion 131 may be 0.1 mm to 4 mm, specifically 0.5 mm to 3 mm, and more specifically 1 mm to 2 mm.

(c) of FIG. 4 is a view illustrating a bonded body 11 of the first metal plate 111 and the second metal plate 121 formed by rolling the bonded portion 131 according to one embodiment.

In one embodiment, the step S30 of forming the bonded body 11 of the first metal plate 111 and the second metal plate 121 may include a first surface rolling step S31 of performing rolling on one exposed surface of the bonded portion 131 and a second surface rolling step S32 of performing rolling on the other exposed surface of the bonded portion 131.

That is, in one embodiment, in the step S30 of forming a bonded body 11 of the first metal plate 111 and the second metal plate 121 by rolling the bonded portion 131 while maintaining the positioning of the bonded portion 131, the rolling may include performing the first surface rolling step S31 of rolling one exposed surface of the bonded portion 131 and the second surface rolling step S32 of rolling the other exposed surface of the bonded portion 131, each one or more times.

In one embodiment, the first surface rolling step S31 may mean performing rolling on one exposed surface of the bonded portion 131. As described above, the first metal plate 111 and the second metal plate 121 may be prepared in a plate shape, and the bonded portion 131 may mean a portion where the first metal plate 111 and the second metal plate 121 are in contact with or adjacent to each other in a plate thickness direction. In this case, the “one exposed surface” in the first surface rolling step S31 may mean an outer surface of the bonded portion 131 when viewed in the plate thickness direction of the bonded portion 131.

In one embodiment, the second surface rolling step S32 may mean performing rolling on the other exposed surface of the bonded portion 131. In this case, with reference to the above-described first surface rolling step S31, the “other exposed surface” in the second surface rolling step S32 may mean an outer surface of the bonded portion 131 when viewed in a direction opposite to that in the first surface rolling step S31.

In one embodiment, the first surface rolling step S31 and the second surface rolling step S32 may mean performing rolling by a rolling method commonly employed in the art to which the present disclosure pertains, for example, a rolling method using a roll press. According to an exemplary embodiment, the rolling may be performed in a manner of pressing a region including both the one exposed surface and the other exposed surface.

In one embodiment, the first surface rolling step S31 and the second surface rolling step S32 may each be performed one or more times. As a non-limiting example, the first surface rolling step S31 and the second surface rolling step S32 may be performed alternately. When the first surface rolling step S31 and the second surface rolling step S32 are performed alternately, the rolling may be performed in different directions, or after performing first rolling on one surface of the first metal plate 111 and the second metal plate 121 positioned in step S20, the rolled first metal plate 111 and the second metal plate 121 may be flipped while maintaining the bonded portion 131, and second rolling may be performed in the same direction, and then the rolled first metal plate 111 and the second metal plate 121 may be flipped again while maintaining the bonded portion 131, and third rolling may be performed in the same direction, the above process being repeated n times.

When rolling is performed as described above, in one embodiment, due to the high ductility of the second metal plate 121 made of lithium metal, the first metal plate 111 and the second metal plate 121 can be smoothly bonded. When the first surface rolling step S31 and the second surface rolling step S32 are each repeatedly performed two or more times, bonding can be achieved more smoothly.

In one embodiment, the method may further comprise a step S40 of notching the bonded body 11 of the first metal plate 111 and the second metal plate 121, the notching step S40 may be performed such that the bonded portion 131 is included, with at least a portion of the first metal plate 111 included on one side adjacent to the bonded portion 131, and at least a portion of the second metal plate 121 included on the other side adjacent to the bonded portion 131.

(d) of FIG. 4 is a view schematically illustrating a step of notching the bonded body 11 formed in the step S30 of forming the bonded body according to one embodiment, such that the bonded portion 131 is included, with at least a portion of the first metal plate 111 included on one side adjacent to the bonded portion 131, and at least a portion of the second metal plate 121 included on the other side adjacent to the bonded portion 131. By the notching step S40, a negative electrode having a predetermined shape may be formed. The shape may be the same as the shape of a mold when the notching is performed by a press process, and may mean an arbitrary predetermined cutting shape when the notching is performed by a laser notching process.

According to an exemplary embodiment, the first region 110 of the negative electrode 10 according to one embodiment of the present disclosure may mean, in the negative electrode 10 formed according to step S40, a region including the first metal plate 111 other than the bonded portion 131 region in step S20. According to an exemplary embodiment, the second region 120 of the negative electrode 10 according to one embodiment of the present disclosure may mean, in the negative electrode 10 formed according to step S40, a region including the second metal plate 121 other than the bonded portion 131 region in step S20. According to an exemplary embodiment, the third region 130 of the negative electrode 10 according to one embodiment of the present disclosure may mean, in the negative electrode 10 formed according to step S40, the bonded portion 131 region in step S20.

The first region 110 may be in contact with a negative electrode tab as described in the explanation of the negative electrode according to one embodiment of the present disclosure.

(d) of In FIG. 4, the notching position and notching shape according to one embodiment are illustrated; however, the present disclosure is not necessarily limited thereto, and notching may be performed in various shapes at various positions as necessary.

The method of manufacturing a negative electrode according to one embodiment of the present disclosure as described above can simplify the process compared to the manufacturing method of a conventional lithium metal negative electrode, reduce material costs to improve economic efficiency and mass productivity, and further, since the first metal plate and the second metal plate are effectively bonded to improve bonding characteristics, the structural stability of the manufactured negative electrode can be secured, and a secondary battery including the same can exhibit excellent battery characteristics.

### Lithium Secondary Battery

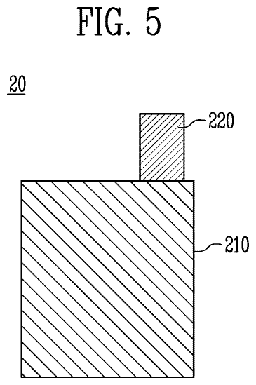

FIG. 5 is a view for explaining a positive electrode according to one embodiment of the present disclosure.

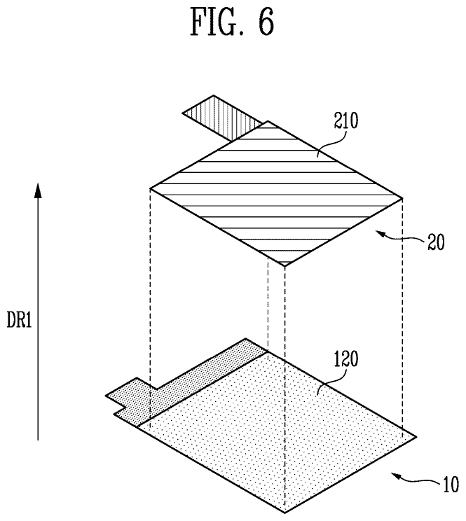

FIG. 6 is a view showing an embodiment of an arrangement relationship between a positive electrode and a negative electrode according to one embodiment of the present disclosure.

The lithium secondary battery according to one embodiment of the present disclosure may include a positive electrode 20 and a negative electrode 10 according to one embodiment of the present disclosure.

Accordingly, the lithium secondary battery according to one embodiment of the present disclosure may be a lithium metal battery.

According to an exemplary embodiment, the positive electrode may include a positive electrode current collector and a positive electrode active material layer disposed on at least one surface of the positive electrode current collector.

According to an exemplary embodiment, the positive electrode current collector may include stainless steel, nickel, aluminum, titanium, or an alloy thereof. The positive electrode current collector may also include aluminum or stainless steel surface-treated with carbon, nickel, titanium, or silver. The positive electrode current collector is not limited thereto, but may have a thickness of, for example, 10 to 50 μm.

According to an exemplary embodiment, the positive electrode active material layer may include a positive electrode active material. The positive electrode active material may include a compound capable of reversibly intercalating and deintercalating lithium ions. The positive electrode active material layer is not limited thereto, but may have a thickness of, for example, 10 to 40 μm.

According to exemplary embodiments, the positive electrode active material may include a lithium-nickel metal oxide. The lithium-nickel metal oxide may further include at least one of cobalt (Co), manganese (Mn), and aluminum (AI).

In some embodiments, the positive electrode active material or the lithium-nickel metal oxide may include a layered structure or a crystal structure represented by the following Chemical Formula 1.

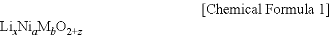

In Chemical Formula 1, x may be 0.9≤x≤1.2, a may be 0.6≤a≤0.99, b may be 0.01≤b≤0.4, and z may be −0.5≤z≤0.1. As described above, M may include Co, Mn, and/or Al.

The chemical structure represented by Chemical Formula 1 indicates bonding relationships included in the layered structure or crystal structure of the positive electrode active material and does not exclude other additional elements. For example, M may include Co and/or Mn, and Co and/or Mn may be provided as a main active element of the positive electrode active material together with Ni. Chemical Formula 1 is provided to represent the bonding relationships of the main active elements and should be understood to encompass the introduction and substitution of additional elements.

In one embodiment, additional auxiliary elements for improving the chemical stability of the positive electrode active material or the layered/crystal structure may be further included in addition to the main active elements. The auxiliary elements may be incorporated together into the layered/crystal structure to form bonds, and in this case as well, they should be understood to be included within the scope of the chemical structure represented by Chemical Formula 1.

The auxiliary elements may include at least one selected from Na, Mg, Ca, Y, Ti, Hf, V, Nb, Ta, Cr, Mo, W, Fe, Cu, Ag, Zn, B, Al, Ga, C, Si, Sn, Sr, Ba, Ra, P, or Zr. For example, the auxiliary elements may act as auxiliary active elements contributing to the capacity/output activity of the positive electrode active material together with Co or Mn, such as Al.

For example, the positive electrode active material or the lithium-nickel metal oxide may include a layered structure or a crystal structure represented by the following Chemical Formula 1-1.

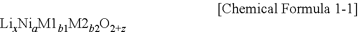

In Chemical Formula 1-1, M1 may include Co, Mn, and/or Al. M2 may include the above-described auxiliary elements. In Chemical Formula 1-1, x may be 0.9$x$1.2, a may be 0.6≤a≤0.99, b1+b2 may be 0.01≤b1+b2≤0.4, and z may be −0.5≤z≤0.1.

The positive electrode active material may further include a coating element or a doping element. For example, elements substantially identical or similar to the above-described auxiliary elements may be used as the coating element or the doping element. As an example, one or a combination of two or more of the above-described elements may be used as the coating element or the doping element.

The coating element or the doping element may be present on the surface of lithium-nickel metal oxide particles, or may penetrate through the surface of the lithium-nickel metal composite oxide particles to be included in the bonding structure represented by Chemical Formula 1 or Chemical Formula 1-1.

The positive electrode active material may include a nickel-cobalt-manganese (NCM)-based lithium oxide. In this case, an NCM-based lithium oxide having an increased content of nickel may be used.

Ni may be provided as a transition metal associated with the output and capacity of a lithium secondary battery. Therefore, by adopting a high-nickel (High-Ni) composition in the positive electrode active material as described above, a high-capacity positive electrode and a high-capacity lithium secondary battery can be provided.

However, as the content of Ni increases, the long-term storage stability and lifespan stability of the positive electrode or the secondary battery may be relatively reduced, and side reactions with the electrolyte may also increase. However, according to exemplary embodiments, by including Co, electrical conductivity can be maintained, and by including Mn, lifespan stability and capacity retention characteristics can be improved.

The content of Ni in the NCM-based lithium oxide (for example, the molar fraction of nickel among the total number of moles of nickel, cobalt, and manganese) may be 0.6 or more, 0.7 or more, or 0.8 or more. In some embodiments, the content of Ni may be 0.8 to 0.95, 0.82 to 0.95, 0.83 to 0.95, 0.84 to 0.95, 0.85 to 0.95, or 0.88 to 0.95.

In some embodiments, the positive electrode active material may further include a lithium cobalt oxide-based active material, a lithium manganese oxide-based active material, a lithium nickel oxide-based active material, or a lithium iron phosphate (LFP) active material (for example, LiFePO₄).

The positive electrode active material layer may further include a positive electrode binder and a conductive material. If necessary, the positive electrode active material layer may further include a thickener. In some embodiments, the positive electrode binder may include polyvinylidene fluoride (PVDF), poly(vinylidene fluoride-co-hexafluoropropylene), polyacrylonitrile, polymethyl methacrylate, or butadiene rubber. In one embodiment, a PVDF-based binder may be used as the positive electrode binder.

The conductive material may be added to improve the conductivity of the active material layer and/or the mobility of lithium ions or electrons. For example, the conductive material may include carbon-based conductive materials such as graphite, carbon black, acetylene black, Ketjen black, graphene, carbon nanotubes (CNT), VGCF (vapor-grown carbon fiber), or carbon fibers, and/or metal-based conductive materials such as tin, tin oxide, titanium oxide, perovskite materials such as LaSrCoO₃ or LaSrMnO₃, but is not limited thereto.

If necessary, the active material layer may further include a thickener and/or a dispersant. As one example, the active material layer may include a thickener such as carboxymethyl cellulose (CMC).

The positive electrode may be prepared, for example, by mixing a positive electrode active material in a solvent to produce a positive electrode slurry. The positive electrode slurry may be coated on the positive electrode current collector, and then dried and rolled to form a positive electrode active material layer. The coating process may be carried out by, for example, gravure coating, slot die coating, multilayer simultaneous die coating, imprinting, doctor blade coating, dip coating, bar coating, or casting, but is not limited thereto. As described above, the positive electrode active material layer may further include a binder, and optionally, may further include a conductive material, a thickener, and the like.

Meanwhile, referring to FIG. 5, an example of the positive electrode 20 according to one embodiment is illustrated. In one embodiment, the positive electrode 20 may include: a positive electrode coated portion 210, which is a region in which the positive electrode active material layer is formed on at least one surface of the positive electrode current collector; and a positive electrode uncoated portion 220, which protrudes outward from the positive electrode coated portion 210.

The positive electrode coated portion 210 may refer to a region in which the positive electrode active material layer is formed on the positive electrode current collector. In other words, in the positive electrode coated portion 210, the positive electrode active material layer may be formed on at least one surface of the positive electrode current collector.

The positive electrode uncoated portion 220 may protrude outward from the positive electrode coated portion 210. Unlike the positive electrode coated portion 210, the positive electrode uncoated portion 220 may have no positive electrode active material layer formed on either surface of the positive electrode current collector. In other words, in the positive electrode uncoated portion 220, the positive electrode current collector may be exposed to the outside on both surfaces.

At least a portion of the positive electrode uncoated portion 220 may be in contact with a positive electrode tab. The positive electrode tab may refer to a configuration for electrically connecting the positive electrode and a lead.

In one embodiment, the positive electrode tab may include aluminum or nickel. In a specific embodiment, the positive electrode tab may include aluminum.

Referring to FIG. 6, an example of an arrangement relationship between the positive electrode 20 and the negative electrode 10 in the lithium secondary battery is illustrated. Meanwhile, in FIG. 6, only one positive electrode 20 and one negative electrode 10 are illustrated for convenience of explanation; however, it is to be understood that one or more positive electrodes 20 and one or more negative electrodes 10 may be provided, as will be described later.

In one embodiment, the lithium secondary battery may include one or more of the positive electrodes 20 and the negative electrodes 10, and the positive electrodes 20 and the negative electrodes 10 may be alternately stacked along a first direction DR1.

In one embodiment, the positive electrodes 20 and the negative electrodes 10 may each be provided in plurality, and the plurality of positive electrodes 20 and the plurality of negative electrodes 10 may be alternately stacked along the first direction DR1.

Meanwhile, the first direction DR1 may refer to a stacking direction of the positive electrodes 20 and the negative electrodes 10. In one embodiment, the positive electrodes 20 and the negative electrodes 10 may be alternately stacked along the first direction DR1 such that a separator (not shown) is interposed between the positive electrodes 20 and the negative electrodes 10.

The separator (not shown) may be configured to prevent an electrical short circuit between the positive electrode 20 and the negative electrode 10, and to allow the flow of ions. In some embodiments, the thickness of the separator (not shown) may be 10 μm to 20 μm; however, the present disclosure is not limited thereto.

For example, the separator (not shown) may include a porous polymer film or a porous nonwoven fabric. The porous polymer film may include a polyolefin-based polymer, such as an ethylene polymer, a propylene polymer, an ethylene/butene copolymer, an ethylene/hexene copolymer, or an ethylene/methacrylate copolymer. The porous nonwoven fabric may include high-melting-point glass fibers or polyethylene terephthalate fibers. The separator (not shown) may also include a ceramic-based material. For example, inorganic particles may be coated on the polymer film or dispersed in the polymer film to improve heat resistance.

The separator (not shown) may have a single-layer or multi-layer structure including the above-described polymer film and/or nonwoven fabric.

In a different embodiment, the secondary battery may employ a solid electrolyte, and in such a case, a solid electrolyte layer may be disposed between the positive electrode 20 and the negative electrode 10 instead of, or together with, the above-described separator (not shown).

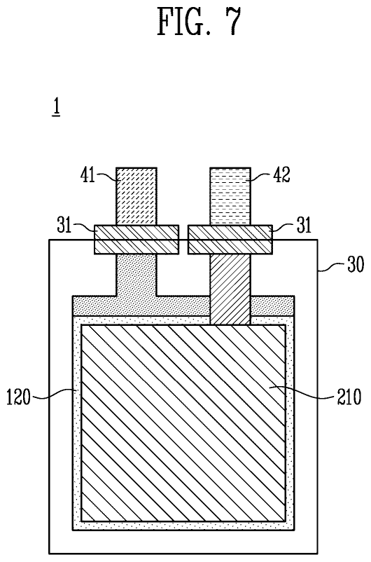

FIG. 7 is a view for explaining an embodiment of a lithium secondary battery according to one embodiment of the present disclosure.

Referring to FIGS. 6 and 7, in one embodiment, when the lithium secondary battery 1 is orthogonally projected onto an imaginary plane perpendicular to the first direction DR1, the positive electrode coating portion 210 may be included in the second region 120 of the negative electrode 10.

In one embodiment, the area of the positive electrode coating portion 210 may be smaller than the area of the second region 120. Meanwhile, as described above, the positive electrode 20 and the negative electrode 10 may be alternately stacked along the first direction DR1, and in this case, the positive electrode coating portion 210 may be stacked to overlap the second region 120 with respect to the first direction DR1. In such an embodiment, when the positive electrode 20 and the negative electrode 10 are orthogonally projected onto an imaginary plane perpendicular to the first direction DR1, the positive electrode coating portion 210 may be included in the second region 120 of the negative electrode 10.

Referring to FIG. 7, in one embodiment, the lithium secondary battery 1 may include a case 30 accommodating the positive electrode 20 and the negative electrode 10 therein, and an electrolyte accommodated in the case 30 and impregnating the positive electrode 20 and the negative electrode 10.

The electrolyte may be accommodated in the case 30 together with an electrode assembly including the positive electrode 20, the negative electrode 10, and the separator (not shown) described above, thereby defining a battery according to one embodiment of the present disclosure. According to exemplary embodiments, a non-aqueous electrolyte may be used as the electrolyte.

The non-aqueous electrolyte may include a lithium salt as an electrolyte and an organic solvent, wherein the lithium salt may be represented, for example, as Li⁺X⁻, and examples of the anion (X⁻) of the lithium salt may include F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, and (CF₃CF₂SO₂)₂N⁻.

The organic solvent may include an organic compound having sufficient solubility for the lithium salt and an additive, and being non-reactive in the battery. The organic solvent may include at least one selected from carbonate-based solvents, ester-based solvents, ether-based solvents, ketone-based solvents, alcohol-based solvents, and aprotic solvents. Examples of the organic solvent may include propylene carbonate (PC), ethylene carbonate (EC), butylene carbonate, diethyl carbonate (DEC), dimethyl carbonate (DMC), ethyl methyl carbonate (EMC), methyl propyl carbonate, ethyl propyl carbonate, dipropyl carbonate, vinylene carbonate, methyl acetate (MA), ethyl acetate (EA), n-propyl acetate (n-PA), 1,1-dimethylethyl acetate (DMEA), methyl propionate (MP), ethyl propionate (EP), fluoroethyl acetate (FEA), difluoroethyl acetate (DFEA), trifluoroethyl acetate (TFEA), dibutyl ether, tetraethylene glycol dimethyl ether (TEGDME), diethylene glycol dimethyl ether (DEGDME), dimethoxyethane, tetrahydrofuran (THF), 2-methyltetrahydrofuran, ethyl alcohol, isopropyl alcohol, dimethyl sulfoxide, acetonitrile, dimethoxyethane, diethoxyethane, sulfolane, gamma-butyrolactone, and propylene sulfite. These may be used alone or in combination of two or more.

The non-aqueous electrolyte may further include an additive. The additive may include, for example, cyclic carbonate compounds, fluorine-substituted carbonate compounds, sultone compounds, cyclic sulfate compounds, cyclic sulfite compounds, phosphate compounds, and borate compounds.

However, as described above, when the lithium secondary battery includes a solid electrolyte layer, the electrolyte using the non-aqueous electrolyte may or may not be included.

Meanwhile, as described above, a negative electrode tab 41 in contact with at least a portion of the first region 110 of the negative electrode 10 and a positive electrode tab 42 in contact with at least a portion of the uncoated portion 220 of the positive electrode 20 may be provided. The positive electrode tab 42 and the negative electrode tab 41 may have a shape protruding in one direction and may extend to one side of the case. The negative electrode tab 41 and the positive electrode tab 42 may be drawn out to the outside through a sealing portion 31 included in at least a part of the case 30.

In some embodiments, the electrode assembly may be in a winding type, a stacking type, a z-folding type, or a stack-folding type.

Examples of the case may include a pouch-type case, a prismatic case, a cylindrical case, and a coin-type case.

The lithium secondary battery according to an embodiment of the present disclosure may be used not only in a battery cell serving as a power source for a small device but also preferably as a unit cell in a battery module including a plurality of battery cells for medium- and large-sized devices. Examples of the small device may include a mobile phone, a notebook computer, and a camera, and examples of the medium- and large-sized devices may include an electric vehicle, a hybrid electric vehicle, a plug-in hybrid electric vehicle, and a power storage system, but are not limited thereto.

Hereinafter, embodiments of the present disclosure will be further described with reference to specific Experimental Examples. The embodiments and Comparative Examples included in the Experimental Examples are merely illustrative of the present invention and are not intended to limit the appended claims. It will be apparent to those skilled in the art that various changes and modifications of the embodiments are possible within the scope and spirit of the present disclosure, and it is naturally understood that such changes and modifications also fall within the scope of the appended claims.

### Embodiment

### Example 1

### (1) Preparation of Negative Electrode

A rectangular copper foil having a thickness of 8 μm and a rectangular lithium metal foil having a thickness of 100 μm were prepared. The copper foil and the lithium metal foil were positioned in parallel such that they overlapped by 2 mm, and one side of the overlapping portion was rolled using a roll press. After rolling, while adjusting to maintain the overlapping portion, the rolling direction was changed, and the overlapping portion was rolled again using the roll press. This process was repeated three times to form a bonded body. The bonded body was then notched into a predetermined shape and size including both the copper foil region and the lithium metal foil region, thereby preparing the negative electrode. The structure of the prepared negative electrode may refer to the structure of the negative electrode shown in FIG. 1. In the prepared negative electrode, the area of the region 130 in which the copper foil and the lithium metal foil were bonded was calculated to be 3.7% of the total area of the negative electrode 10.

### (2) Preparation of Positive Electrode

A positive electrode slurry was prepared by mixing NCM811 as a positive electrode active material, SUPER-P as a conductive material, and PVDF as a binder in a weight ratio of 95:2.5:2.5, using N-methylpyrrolidone as a solvent. The slurry was then applied onto an aluminum thin film having a thickness of 12 μm so as to form uncoated portions of about 150 mm on both sides in the width direction, dried, rolled, and then notched into a predetermined shape and size to prepare a positive electrode in which a positive electrode active material layer was formed.

### (3) Manufacture of Battery

The positive electrode and the negative electrode prepared as described above were stacked with a separator (PE, 9 μm) interposed therebetween, inserted into a pouch, and assembled into a battery.

The electrolyte was prepared by adding 0.8 M LiTFSI, 0.2 M LiDFOB, and 0.05 M LiPF₆ salts to a solvent obtained by mixing fluoroethylene carbonate (FEC) and ethyl methyl carbonate (EMC) at a volume ratio of 25:75, and the prepared solution was injected into the pouch.

An aluminum positive electrode tab was ultrasonically welded and grounded to the uncoated portion of the positive electrode where the positive electrode active material layer was not formed, and a nickel negative electrode tab was ultrasonically welded and grounded to the copper foil region of the negative electrode. Thereafter, the pouch was sealed, and leads were connected to each tab to manufacture a lithium metal battery.

### Example 2

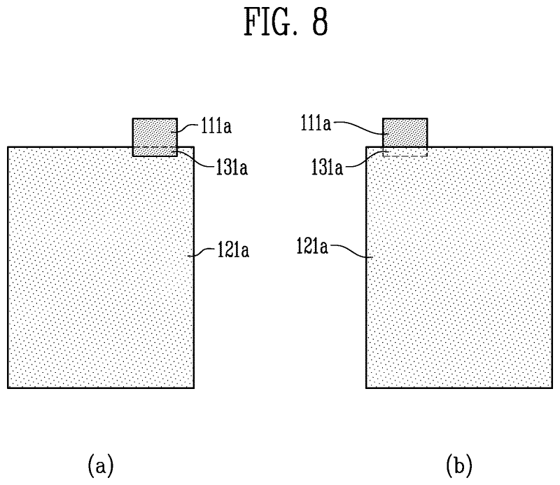

FIG. 8 is a view for explaining a structure of a negative electrode according to Example 2. (a) of FIG. 8 is a view showing the negative electrode according to Example 2 as viewed from one direction, and (b) of FIG. 8 is a view showing the negative electrode of (a) of FIG. 8 as viewed from a direction opposite to the one direction.

### (1) Preparation of Negative Electrode

A rectangular copper foil 111a having a predetermined size and a thickness of 8 μm, and a rectangular lithium metal foil 121a having a predetermined size and a thickness of 100 μm were prepared. The copper foil 111a and the lithium metal foil 121a were positioned to overlap partially while being arranged in parallel, and one side of the overlapping portion was rolled with a roll press. After rolling, while adjusting so that the overlapping portion was maintained, the rolling direction was changed and the overlapping portion was rolled again with the roll press. The structure of the negative electrode prepared as described above may be referred to in FIG. 8, and in the negative electrode prepared as described above, the area of the bonded portion 131a where the copper foil 111a and the lithium metal foil 121a are joined was calculated to be 0.041% of the total area of the negative electrode 10.

### (2) Manufacture of Battery

Except for preparing the negative electrode as described above, a lithium metal battery was manufactured in the same manner as in Example 1.

### Comparative Example 1

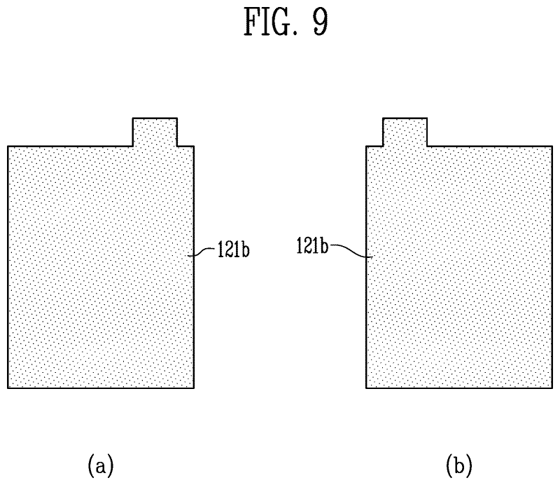

FIG. 9 is a view for explaining a structure of a negative electrode according to Comparative Example 1. (a) of FIG. 9 is a view showing a negative electrode according to Comparative Example 1 as viewed from one direction, and (b) of FIG. 9 is a view showing the negative electrode of (a) of FIG. 9 as viewed from a direction opposite to the one direction.

### (1) Preparation of Negative Electrode

A rectangular lithium metal foil 121b having a thickness of 100 μm was prepared, and then notched into the same shape and size as in Example 1 to prepare a negative electrode. The structure of the prepared negative electrode can be referred to in the structure of the negative electrode shown in FIG. 9.

### (2) Manufacture of Battery

Except that the negative electrode was prepared as described above and that the Ni negative electrode tab was welded to the lithium metal foil, a lithium metal battery was manufactured in the same manner as in Example 1.

### Reference Example

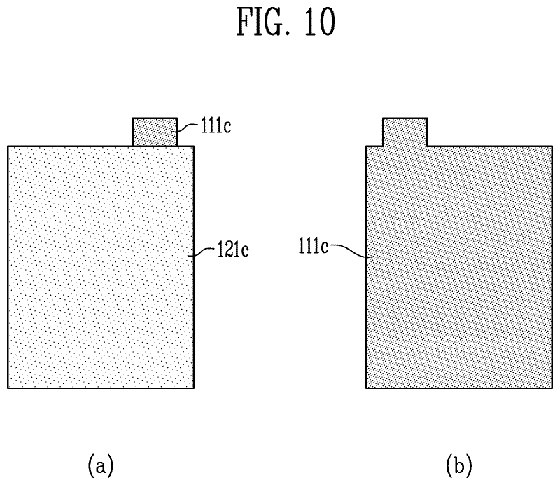

FIG. 10 is a view for explaining a structure of a negative electrode according to Reference Example. (a) of FIG. 10 is a view showing the negative electrode according to the Reference Example as viewed from one direction, and (b) of FIG. 10 is a view showing the negative electrode of (a) of FIG. 10 as viewed from a direction opposite to the one direction.

### (1) Preparation of Negative Electrode

A rectangular copper foil 111c having a thickness of 8 μm was prepared and notched into the same shape and size as in Example 1. A rectangular lithium metal foil 121c having a predetermined size and a thickness of 100 μm was attached to one surface of the copper foil 111c to prepare a negative electrode. The structure of the negative electrode thus prepared can be referred to in FIG. 10.

### (2) Manufacture of Battery

Except for preparing the negative electrode as described above, a lithium metal battery was manufactured in the same manner as in Example 1.

### Evaluation Example

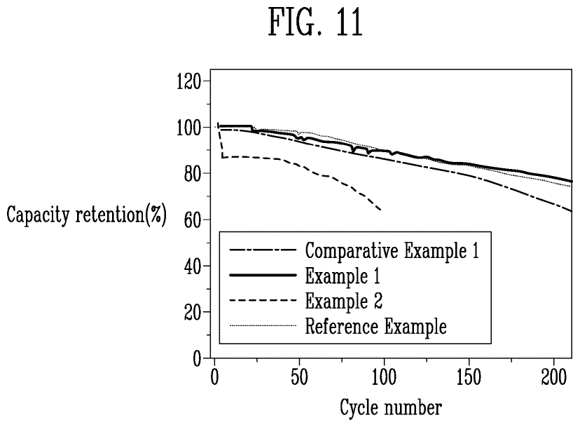

FIG. 11 is a graph showing evaluation results of lifespan characteristics of cells of Example 1, Example 2, Comparative Example 1, and Reference Example.

For the batteries of Example 1, Example 2, Comparative Example 1, and the Reference Example, charging (CC/CV 0.33C 4.2V 0.05C cut-off) and discharging (0.5C 3V cut-off) were repeated approximately 200 times as one cycle, while measuring the discharge capacity. A graph showing the discharge capacity measured for each cycle is presented in FIG. 11.

As shown in FIG. 11, the battery of Example 1 exhibited a higher capacity than the battery of Comparative Example 1, and as a result, it was confirmed that the cycle life characteristics were superior.

This is considered to be because, in the case of the battery of Comparative Example 1 in which a tab made of another metal material is directly welded to the lithium metal foil, the mechanical and thermal energy generated during the welding process may cause deterioration of the physical properties, thereby degrading the battery performance, and also because, in the portion of the lithium metal foil where the tab is welded, the current density locally increases during the charging and discharging processes, leading to rapid consumption of lithium and consequently degrading the cell performance.

Meanwhile, in the case of the battery of Example 2, in which the area of the bonded region between the copper foil and the lithium metal foil is less than 0.05% of the total area of the negative electrode, it is considered that the adhesion properties between the copper foil and the lithium metal foil are poor, resulting in inferior electron transfer characteristics during charging and discharging, and thus rather degrading the cell performance.

Meanwhile, as shown in FIG. 11, it was confirmed that the battery of Example 1 exhibited a lifetime characteristic at a level similar to that of the battery of Reference Example.

The battery of Reference Example is a lithium metal negative electrode of a conventional technology type in which lithium metal is attached to a copper foil current collector, and it has significantly inferior volumetric energy density and gravimetric energy density compared to the battery of Example 1. Accordingly, it was confirmed that the battery of Example 1 can exhibit superior energy density compared to the battery or Reference Example while simultaneously exhibiting similar lifetime characteristics, and as a result, can exhibit superior cell performance compared to the battery of Reference Example.

The above description is merely an example of applying the principles of the present disclosure, and other configurations may be further included within a scope not departing from the scope of the present disclosure.

What is claimed is:

1. A negative electrode comprising:
a first region including a first metal and a second region including a second metal,
wherein at least a portion of the first region is in contact with a negative electrode tab,
wherein the first metal and the second metal are different from each other, and the second metal is lithium metal.

2. The negative electrode according to claim 1, wherein the first region includes at least one selected from the group consisting of a metal film including the first metal, a metal mesh including the first metal, and an alloy including the first metal.

3. The negative electrode according to claim 1, wherein the first metal is a metal having higher electrical conductivity than lithium.

4. The negative electrode according to claim 1, wherein the first metal includes copper.

5. The negative electrode according to claim 2, wherein the alloy includes copper and zinc.

6. The negative electrode according to claim 1, further comprising a third region located between the first region and the second region, the third region including both the first metal and the second metal.

7. The negative electrode according to claim 6, wherein the first region includes a first metal plate including the first metal, the second region includes a second metal plate made of the second metal, and
the third region has the first metal plate exposed on one surface thereof and the second metal plate exposed on the other surface thereof.

8. The negative electrode according to claim 6, wherein a width of the third region is 0.1 mm to 4 mm.

9. The negative electrode according to claim 6, wherein an area of the third region is 0.05% to 5% of an entire area of the negative electrode.

10. A method of manufacturing the negative electrode of claim 1, comprising:
preparing a first metal plate including the first metal and a second metal plate including the second metal;
positioning the first metal plate and the second metal plate to form a bonded portion in which at least a portion of the first metal plate and at least a portion of the second metal plate overlap each other; and
forming a bonded body of the first metal plate and the second metal plate by rolling the bonded portion while maintaining the positioning.

11. The method of manufacturing the negative electrode according to claim 10, wherein a width of the bonded portion is 0.1 mm to 4 mm.

12. The method of manufacturing the negative electrode according to claim 10, wherein the forming of the bonded body of the first metal plate and the second metal plate comprises a first surface rolling step of performing rolling on one exposed surface of the bonded portion and a second surface rolling step of performing rolling on the other exposed surface of the bonded portion.

13. The method of manufacturing the negative electrode according to claim 10, further comprising notching the bonded body of the first metal plate and the second metal plate,
wherein the notching is performed such that the bonded portion is included, at least a portion of the first metal plate is included on one side adjacent to the bonded portion, and at least a portion of the second metal plate is included on the other side adjacent to the bonded portion.

14. A lithium secondary battery comprising:
a positive electrode; and
the negative electrode according to claim 1,
wherein the positive electrode comprises a positive electrode coated portion which is a region where a positive electrode active material layer is formed on at least one surface of a positive electrode current collector, and a positive electrode uncoated portion protruding outward from the positive electrode coated portion.

15. The lithium secondary battery according to claim 14, comprising at least one of the positive electrode and at least one of the negative electrode,
wherein the positive electrode and the negative electrode are alternately stacked along a first direction.

16. The lithium secondary battery according to claim 15, wherein, when the lithium secondary battery is orthogonally projected onto an imaginary plane perpendicular to the first direction, the positive electrode coated portion is included in the second region of the negative electrode.
